(19) United States
(12) Patent Application Publication
(10) Pub. No.: US 2025/0263061 A1
(43) Pub. Date: Aug. 21, 2025

(54) HYBRID MODE DETERMINATION METHOD BASED ON VEHICLE LOAD

(71) Applicant: Cummins Inc., Columbus, IN (US)

(72) Inventors: Meng Xu, Beijing (CN); Shiyu Hu, Beijing (CN); Chengxiu Huang, Beijing (CN); Yuan Zoe, Wuhan (CN)

(73) Assignee: Cummins Inc., Columbus, IN (US)

(21) Appl. No.: 19/054,777

(22) Filed: Feb. 15, 2025

(30) Foreign Application Priority Data
Feb. 18, 2024 (CN) 2024101815677

(51) Int. Cl. B60W 20/13; B60W 20/20

(52) U.S. Cl. CPC B60W 20/13; B60W 20/20; B60W 2510/242; B60W 2520/10; B60W 2530/10

(57) ABSTRACT

A system for a vehicle includes a controller including at least one processing circuit including at least one memory coupled to at least one processor. The controller is configured to receive a value regarding a weight of the vehicle, receive a value indicative of an operating condition of an energy storage device coupled to the controller, set, based on the value indicative of the operating condition of the energy storage device, a speed threshold for the vehicle, set, based on the value indicative of the operating condition of the energy storage device, a first power threshold and a second power threshold, receive a current speed and a power demand, and in response to determining that the current speed is greater than the speed threshold, implement, based on the power demand, a predefined drive mode of a plurality of drive modes for the vehicle.

### CROSS-REFERENCE TO RELATED APPLICATIONS

The present application claims priority to Chinese Patent Application No. 2024101815677, filed Feb. 18, 2024, the contents of which are incorporated herein by reference.

### TECHNICAL FIELD

The present disclosure relates to systems and methods for selection of a drive mode and automatic or nearly automatic implementation to provide various technical operation improvements, such as improved fuel economy for a hybrid powertrain vehicle.

### BACKGROUND

Hybrid powertrains can propel a vehicle using one or more electric motor-generators and an internal combustion engine. The motor generator can mechanically couple to a drivetrain to directly provide power thereto and mechanically couple to an energy storage device to provide electrical energy for storage. The internal combustion engine can mechanically couple to the drivetrain to also directly provide power thereto. Hybrid powertrains may be appealing due to their less reliance on internal combustion engines to propel the vehicle, and that they reduce energy consumption that then reduces the cost of operation.

### SUMMARY

One embodiment relates to system for a vehicle. The system includes a controller. The controller includes at least one processing circuit including at least one memory coupled to at least one processor. The controller is configured to receive a value regarding a weight of a vehicle and receive a value indicative of an operating condition of an energy storage device coupled to the controller. The controller is also configured to set, based on the value indicative of the operating condition of the energy storage device, a speed threshold for the vehicle and set, based on the value indicative of the operating condition of the energy storage device, a first power threshold and a second power threshold. The controller is further configured to receive a current speed and a power demand, and in response to determining that the current speed is greater than the speed threshold, implement, based on the power demand, a predefined drive mode of a plurality of drive modes for the vehicle.

In some embodiments, the controller is further configured to define an energy threshold.

In some embodiments, the controller is further configured to in response to the value of the operating condition of the energy storage device being greater than the energy threshold, set the speed threshold to a predetermined speed.

In some embodiments, the controller is further configured to in response to the value of the operating condition of the energy storage device being less than or equal to the energy threshold, set the speed threshold to zero and the predefined drive mode to one of a recharge mode, an engine drive mode, or a power split mode.

In some embodiments, in response to the value of the operating condition of the energy storage device being greater than or equal to the energy threshold, the controller is further configured to in response to the power demand being less than the first power threshold, set the predefined drive mode to a recharge mode, in response to the power demand being greater than the first power threshold and less than the second power threshold, set the predefined drive mode to an engine drive mode, and in response to the power demand being greater than the second power threshold, set the predefined drive mode to a power split mode.

In some embodiments, the second power threshold is greater than the first power threshold.

In some embodiments, the controller is further configured to in response to the current speed not being greater than the speed threshold, implement an electric drive mode.

In some embodiments, the controller is further configured to adjust at least one of the first power threshold and the second power threshold.

Another embodiment relates to a vehicle. The vehicle includes a motor configured to provide at least a portion of a power demand to the vehicle and a controller coupled to the motor. The controller is configured to: set a speed threshold based on a value regarding a vehicle weight and a value indicative of an operating condition of an energy storage device of the vehicle; implement a drive mode based on the value and the speed threshold; and control, based on the drive mode, the motor.

In some embodiments, the controller is further configured to in response to the value indicative of the operating condition of the energy storage device being less than an energy threshold, set the speed threshold to zero.

In some embodiments, the controller is further configured to in response to a current speed being less than the speed threshold and that the value indicative of the operating condition of the energy storage device being greater than or equal to the energy threshold, implement an electric vehicle drive mode.

In some embodiments, the controller is further configured to set a first power threshold and a second power threshold based on the value indicative of the operating condition of the energy storage device.

In some embodiments, the controller is further configured to in response to the current speed being greater than the speed threshold and the power demand being less than the first power threshold, implement an engine recharge mode wherein the motor provides power to the energy storage device.

In some embodiments, the controller is further configured to in response to the current speed being greater than the speed threshold and the power demand being greater than the first power threshold and less than or equal to the second power threshold, implement an engine only drive mode.

In some embodiments, the controller is further configured to in response to the current speed being greater than the speed threshold and the power demand being greater than the second power threshold, implement a power split mode wherein the motor provides a portion of the power demand to the vehicle.

Still another embodiment relates to a method. The method includes receiving a value regarding a vehicle weight and receiving a value indicative of an operating condition of an energy storage device. The method also includes setting, based on the value indicative of the operating condition of the energy storage device and the value regarding the vehicle weight, a speed threshold and setting, based on the value indicative of the operating condition of the energy storage device, a first power threshold and a second power threshold. The method further includes receiving a current speed and a power demand. The method also includes in response to the current speed being greater than the speed threshold, implementing a predefined drive mode of a plurality of drive modes based on the power demand.

In some embodiments, the method further includes setting an energy threshold, and in response to the value of the operating condition of the energy storage device being less than or equal to the energy threshold, setting the speed threshold to zero and the predefined drive mode to one of a recharge mode, an engine mode, or a power split mode.

In some embodiments, the method further includes in response to the value indicative of the operating condition of the energy storage device being greater than the energy threshold and the power demand being less than the first power threshold, implementing the predefined drive mode to a recharge mode, in response to the value indicative of the operating condition of the energy storage device being greater than the energy threshold and the power demand being greater than the first power threshold and less than the second power threshold, implementing the predefined drive mode to an engine mode, and in response to the value indicative of the operating condition of the energy storage device being greater than the energy threshold and the power demand being greater than the second power threshold, implementing the predefined drive mode to a power split mode.

In some embodiments, the implementing the recharge mode activates a motor to provide power to the energy storage device.

In some embodiments, the method further includes adjusting at least one of the first power threshold and the second power threshold.

Numerous specific details are provided to impart a thorough understanding of embodiments of the subject matter of the present disclosure. The described features of the subject matter of the present disclosure may be combined in any suitable manner in one or more embodiments and/or implementations. In this regard, one or more features of an aspect of the invention may be combined with one or more features of a different aspect of the invention. Moreover, additional features may be recognized in certain embodiments and/or implementations that may not be present in all embodiments or implementations.

### BRIEF DESCRIPTION OF THE FIGURES

FIG. 1 is a block diagram of a system, according to an example embodiment.

FIG. 2 is a block diagram of the controller of the system of FIG. 1, according to an example embodiment.

FIG. 3A is a drive mode decision diagram for enabling a drive mode, according to an example embodiment.

FIG. 3B is a system efficiency map for determining a drive mode, according to an example embodiment.

FIG. 4 is a flow diagram of a method of enabling and implementing a drive mode, according to an example embodiment.

FIG. 5 is another flow diagram of a method of enabling and implementing a drive mode, according to an example embodiment.

FIG. 6 is a graph illustrating speed thresholds for a system, according to an example embodiment.

### DETAILED DESCRIPTION

Following below are more detailed descriptions of various concepts related to, and implementations of, methods, apparatuses, computer-readable media, and systems for enabling and implementing an automatic or nearly automatic drive mode selection for a system. According to various example embodiments, a drive mode may be selected by a controller of the system from a plurality of drive modes based on a vehicle weight or load and a state of charge of the system. Before turning to the Figures, which illustrate certain exemplary embodiments in detail, it should be understood that the present disclosure is not limited to the details or methodology set forth in the description or illustrated in the Figures. It should also be understood that the terminology used herein is for the purpose of description only and should not be regarded as limiting.

As utilized herein, the term “estimating” is used to refer to determining a value that is not a measured value, such as measurements from a real sensor (e.g., a temperature measured by a temperature sensor, etc.). In other words, estimation refers to an approximation of a value(s) that may differ from an actual or measured value. Estimating a value may be based on information from a real sensor (e.g., sensor data, historical sensor data, real-time sensor data, etc.) or information from another source. In some embodiments, estimating the value can be performed using one or more models (e.g., statistical models, artificial intelligence models, machine learning models, etc.). For example, estimating a temperature value can include using data, such as sensor data, with a model to determine the temperature value. As utilized herein, the term “measuring” and like terms are used to refer to determining an approximate value based on detecting or receiving information regarding the desired parameter (e.g., using a sensor). The measured value may be close but not necessarily exactly the actual value of the measured value, yet still a closer or more accurate approximation relative to an “estimated” value.

As utilized herein, the term “predicting” and like terms are used to refer to determining or estimating a future value based on data (e.g., sensor data, historical sensor data, real-time sensor data, etc.). In some embodiments, determining the future value can be performed using one or more models (e.g., statistical models, artificial intelligence models, machine learning models, etc.) and/or other processes or mechanisms (e.g., a lookup table, etc.). For example, predicting a change in temperature of a component may include determining or estimating a current temperature (e.g., based on sensor data) and modeling or looking-up a future temperature of the component based on a change in engine operation, such as enabling an engine braking mode of operation.

As utilized herein, the term “operational data” and like terms are used to refer to data regarding the operation of a system, such as an engine system. In some embodiments, operational data may include settings, values, or other information regarding the operation of a system. The operational data may be measured (e.g., by one or more real sensors), estimated (e.g., by one or more virtual sensors or by a computer device or processing circuit), and/or otherwise determined.

As described herein, a system may include an engine (e.g., an internal combustion engine, etc.), an electric machine (e.g., a motor generator), at least one battery, a transmission, and a controller (e.g., a system controller, SCM, etc.). The system controller may control a drive mode of the engine system affecting the power allocation and fuel economy of the system.

As described herein, a drive mode is a state of operation of the system. The drive mode may enable the system to activate various components to provide power. For example, the drive mode may enable a first portion of the system power to be provided by the engine and a second portion of the system power to be provided by the electric machine. For example, the engine may provide 60% of the system's power demand and the electric machine may provide 40% of the system's power demand. The engine and the electric machine may provide any combination of the first portion of power and the second portion of power, respectively, to satisfy (e.g., meet, etc.) the power demand of the system. In some embodiments, the drive mode may enable the engine to provide the entire power demand of the system. In other embodiments, the electric machine may provide the entire power demand of the system.

To minimize fuel consumption, the system controller may switch the engine system between various drive modes to minimize fuel consumption (e.g., maximize fuel benefit, etc.) and maintain a minimum value regarding one or more desired operating conditions, such as a minimum state of charge (SOC) of one or more batteries of the system. For example, the systems and methods described herein may minimize consumption of fuel when the state of charge of the hybrid vehicle battery is high (e.g., above a predefined high SOC threshold) and minimize consumption of electric power when the state of charge of the hybrid vehicle battery is low (e.g., below a predefined low SOC threshold).

Advantageously, the system controller (e.g., the control system, controller, etc.) may control the operation of the system to automatically or nearly automatically selectively enable a particular drive mode based on various of one or more operating parameters. More particularly and as described herein, the controller may select the drive mode based on one or more of a SOC of the hybrid vehicle battery, the vehicle speed threshold, and the power threshold. Further, the speed threshold may be determined based on a value regarding a vehicle weight (e.g., an estimated vehicle weight, a vehicle mass, vehicle load, etc.) and a current state of charge level. By dynamically examining one or more of these parameters, various advantages may be realized such as minimizing fuel consumption as described herein above.

In some embodiments, the controller may receive data or a value regarding a state of charge, a temperature, or a state of health of the hybrid vehicle battery from one or more sensors (e.g., actual sensors and/or virtual sensors). In some embodiments, the controller may compare the received value (e.g., SOC, temperature, etc.) to one or more thresholds. The controller may determine, at least in part, a drive mode based on the comparison.

In an example embodiment, the value regarding the vehicle weight (e.g., estimated weight, measured weight, vehicle mass, vehicle load etc.) and the value indicative of an operating condition (e.g., the state of charge of the hybrid battery, etc.) is estimated and stored (e.g., in a storage, etc.). For example, the vehicle weight may be determined by one or more weight sensors (e.g., actual sensor and/or virtual sensors) and the state of charge may be determined by one or more charge sensors (e.g., actual sensor and/or virtual sensors). The controller may then set a speed threshold for the vehicle. For example, the speed threshold may be based on at least one of the values regarding the vehicle weight and the value indicative of the operating parameter, such as the state of charge.

The system controller may also set a power threshold. During operation of the system, the controller may receive a current vehicle speed and a Driver Demanded Power (DDP) value. For example, the current vehicle speed may be determined (e.g., estimated, or measured, etc.) by a speed sensor (e.g., an actual sensor or a virtual sensor) and received by the controller. The DDP may be determined by at least one of a sensed Driver Demanded Torque (DDT), an accelerator pedal position (APP), and/or a brake pedal position (BPP). The controller may then compare the current speed to the set speed threshold and the DDP to the set power threshold.

In an example scenario, the current vehicle speed may be below the set speed threshold. If the current vehicle speed is less than or equal the set speed threshold, the controller may enable the engine system to operate in an electric vehicle drive mode (i.e., the drive mode is the electric vehicle drive mode whereby power for the system is provided entirely by an electric machine, e.g., an electric motor or motor generator). For example, when the current vehicle speed is below the speed threshold, the controller may enable the engine system to operate in electric vehicle mode regardless of the received DDP. The controller may enable the electric vehicle drive mode when the current speed is less than or equal to the set speed threshold. For example, when the power demand (e.g., DDP) is relatively low (e.g., at or below a low-speed threshold or within a low-speed range of speeds), the controller may enable the electric vehicle mode. When the controller enables the electric vehicle mode, the controller activates the electric machine (e.g., the motor or motor generator) to provide the demanded power and disables (e.g., shuts off, turns off, idles, etc.) the engine, such that the engine is not providing power.

In another example scenario, the current speed may be greater than the set speed threshold. For example, in this scenario, the received power demand (e.g., DDP) may determine which drive mode the controller enables the system to operate. For example, the set power threshold may include a first threshold (e.g., a lower threshold) and a second threshold (e.g., an upper threshold). If the controller determines that current speed is greater than the speed threshold and the DDP is less than the lower power threshold, the controller may enable the engine system to operate in an engine recharge drive mode. When operating in the engine recharge drive mode, the system power may be provided by the engine while the electric machine (e.g., motor or motor generator) supplies power to the battery to recharge the battery (e.g., the motor generator supplies negative power to charge the battery). When the controller enables the system to operate in the engine recharge drive mode, the controller activates (e.g., enables, etc.) the motor to provide power (e.g., torque, etc.) and enables the electric machine to provide power to the battery. For example, while operating in engine recharge drive mode, the system power may only be provided by the engine, while the electric machine provides power to the energy storage device (e.g., battery(ies), etc.).

In yet another example scenario, the current vehicle speed may be greater than the speed threshold and the DDP may be greater than the lower power threshold but less than the upper power threshold. In this scenario, the controller may enable the system to operate in an engine only drive mode. When the system operates in the engine only drive mode, the system's power is provided only by the engine. For example, the electric machine may be turned off (e.g., shut off, etc.). As described above, when the controller enables the engine only drive mode, the system power is provided by the engine. During engine only drive mode, the electric machine is turned off or otherwise disable. For example, the system energy is not being provided by the electric machine nor is the electric machine providing power to the energy storage device.

In still yet another example scenario, the current vehicle speed may be greater than the speed threshold and the DDP may be greater than the upper limit (e.g., greater than both the lower threshold and the upper threshold, etc.). In this scenario, the controller may then enable the system to operate in a power split mode. When operating in the power split mode, the system power is provided by both the engine and the electric machine. When the controller enables the system to operate in the power split drive mode, a first portion of the system's power is provided by the engine and a second portion of the system's energy is provided by the electric machine. For example, the engine may provide 60% of the power demand, while the electric machine provides 40% of the power demand. In other embodiments, the engine may provide 30% of the power demand, while the electric machine provides 70% of the power demand. The engine and the electric machine may provide any combination of the first portion and the second portion, respectively, to satisfy (e.g., meet, fulfill, etc.) the demanded power.

In each example scenario once the drive mode is selected, the controller may then send at least one command (e.g., a signal, a message, etc.) to activate or deactivate (e.g., enable, disable, etc.) (or, in some embodiments, at least partially activate or deactivate) at least one of the engine and/or the electric machine. In some embodiments, the controller may recheck or receive another value (e.g., an updated value, a predictive value, an estimated value, etc.) indicative of an updated or a change in one or more operating parameters. For example, in some embodiments, the controller may check the state of charge again after a predetermined time has elapsed. In other embodiments, the controller may receive an updated information regarding a temperature of the system. In other embodiments, the controller may receive a state of charge error command. In response to the at least one command, the controller may recheck or receive an updated value regarding, for example, a state of charge of the battery. In response to receiving an updated value regarding one or more operating parameters, the controller may then adjust the lower power threshold and the upper power threshold. For example, the controller may decrease the lower power threshold and decrease the upper power threshold. In some embodiments, the controller may increase the lower power threshold and increase the upper power threshold. In another embodiment, the controller may decrease the lower power threshold and increase the upper threshold or increase the lower power threshold and decrease the upper power threshold.

According to any of the described example scenarios, the speed threshold may be any speed threshold related to the system. For example, in some embodiments the speed threshold may be a vehicle speed threshold. In other embodiments, the speed threshold may be one of an engine speed threshold, a motor generator speed threshold, a transmission speed threshold, an axle speed threshold, or a wheel speed threshold. These and other features and benefits are described more fully herein below.

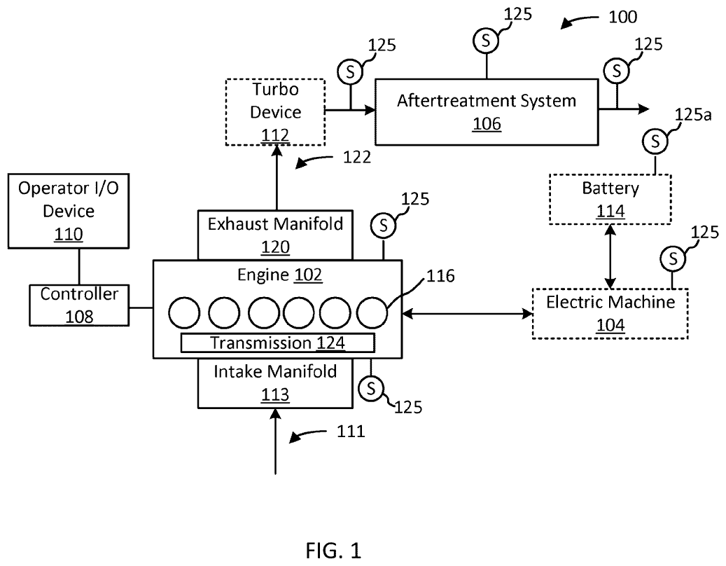

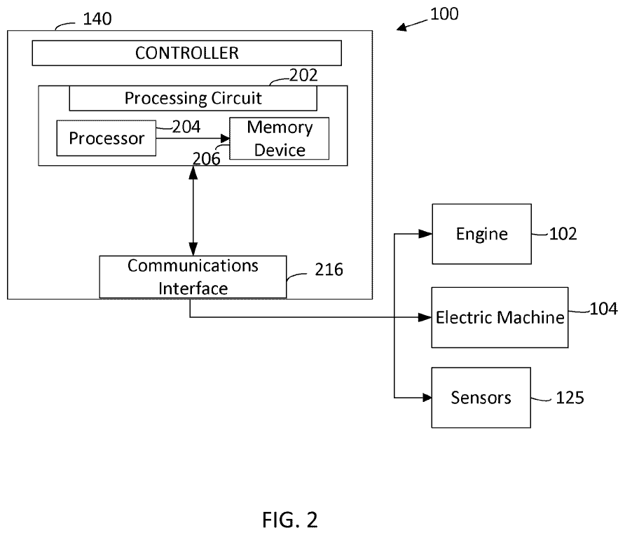

Referring now to FIG. 1, a schematic view of a block diagram of a system 100 (e.g., an engine system, a hybrid powertrain system, etc.) is shown, according to an example embodiment. The system 100 includes an engine 102 and at least one electric machine (e.g., motor, a motor generator, etc.) 104. For example, and with reference to the system shown in FIG. 1, the system 100 may include an electric machine 104 (e.g., a motor, a motor generator, etc.) that is coupled to the engine 102 via a shaft (e.g., an output shaft, a drive shaft, a crankshaft, etc.). The electric machine 104 is electrically coupled to a battery 114, such that the electric machine 104 is operable to receive power from the battery 114 and/or provide power to the battery 114. In some embodiments, the system 100 may be structured as a mild-hybrid powertrain, a strong-hybrid powertrain, a parallel hybrid powertrain, or a series-parallel powertrain. The system 100 may also include an aftertreatment system 106 in exhaust gas receiving communication with the engine 102. The system 100 includes a controller 108 (as shown in FIG. 2) and an operator input/output (I/O) device 110, where the controller 108 is communicably coupled to each of the aforementioned components. Other components and/or systems may also be included in the system 100.

The electric machine 104 is configured to use electrical power (e.g., from the battery 114 or another power source such as an alternator) to output mechanical power. For example, the electric machine 104 may be coupled to a shaft (e.g., an output shaft, a drive shaft, a crankshaft, etc.) such that the shaft is operable to receive power output by the electric machine 104. In some embodiments, the electric machine 104 is coupled to the engine 102 (e.g., via the shaft). In some embodiments, the electric machine 104 is coupled to one or more wheels and/or axles of a vehicle system (e.g., via the shaft), such that the electric machine 104 is operable to provide and/or receive power to/from the wheels and/or axles. For example, the electric machine 104 may provide power to the wheels to propel the system 100. In another example, the electric machine 104 may receive power from the wheels (e.g., during a regenerative braking operation). The electric machine 104 may be a motor, a motor generator, or another electric motive device. Further, multiple electric machines 104 may be included in the system 100.

In some embodiments, the system 100 includes a turbo device 112 disposed between the engine 102 and the aftertreatment system 106, such that the turbo device 112 is in exhaust gas receiving communication with the engine 102 and exhaust gas providing communication with the aftertreatment system 106. In these embodiments, the aftertreatment system 106 is in exhaust gas receiving communication with the engine 102 (e.g., via the turbo device 112). In other embodiments, the system 100 does not include the turbo device 112.

In the configuration of FIG. 1, the system 100 is included in a vehicle. The vehicle may be any type of on-road or off-road vehicle including, but not limited to, wheel-loaders, fork-lift trucks, line-haul trucks, mid-range trucks (e.g., pick-up truck, etc.), sedans, coupes, and any other type of vehicle. In other embodiments, the system 100 may be embodied in a stationary piece of equipment, such as a power generator or genset. All such variations are intended to fall within the scope of the present disclosure.

In the configuration shown in FIG. 1, the engine 102 is an internal combustion engine (ICE). The ICE may consume fuel, such as diesel, gasoline, hydrogen, natural gas, propane, etc., to generate power. The engine 102 is part of a hybrid system (e.g., a hybrid powertrain system, etc.) having a combination of an internal combustion engine and at least one electric machine coupled to at least one battery. For example, and with reference to the system shown in FIG. 1, the system 100 may include an electric machine 104 that is coupled to the engine 102 via a shaft (e.g., an output shaft, a drive shaft, a crankshaft, etc.). The electric machine 104 is electrically coupled to a battery 114, such that the electric machine 104 is operable to receive power from the battery 114 and/or provide power to the battery 114.

The engine 102 includes one or more cylinders 116 (e.g., combustion cylinders). The cylinders 116 are disposed within a combustion chamber of the engine 102. In some embodiments, the engine 102 may be configured as a spark-ignition (SI) engine. In the example shown, the engine 102 is configured as a compression-ignition (CI) engine, and the cylinder 116 does not include an igniter. In some embodiments each cylinder 116 has a corresponding fuel injector. In these embodiments, the fuel injector(s) are configured to provide fuel to a corresponding cylinder 116. In other embodiments, the fuel injector(s) may be positioned upstream of the cylinders 116 (e.g., at or within an intake manifold, such as the intake manifold 113, described herein). In these embodiments, the fuel injector(s) are configured to provide fuel upstream of the cylinders 116 such that the cylinders 116 receive fuel from the fuel injector(s).

Referring to FIG. 1, the engine 102 includes six cylinders 116. However, it should be understood that the engine 102 may include more or fewer cylinder 116 (e.g., at least one) than as shown in FIG. 1. Furthermore, the cylinders 116 may be provided in varying arrangements (e.g., in-line, horizontal, V, or other suitable cylinder arrangement).

The system 100 includes an intake conduit 111 and an intake manifold 113. The intake conduit 111 is configured to route an intake gas stream, including air (e.g., ambient air, compressed air, etc.), to the intake manifold 113. The intake manifold 113 is configured to route the intake gas stream from an intake conduit 111 into the engine 102. More specifically, the intake manifold 113 is configured to route air from the intake conduit 111 to each of the cylinders 116.

The system 100 includes an exhaust manifold 120 and an exhaust conduit 122. The exhaust manifold 120 is configured to route an exhaust gas stream from the engine to the exhaust conduit 122. More specifically, the exhaust manifold 120 is configured to route an exhaust gas stream from each of the cylinders 116 to the exhaust conduit 122. The exhaust conduit 122 is configured to route the exhaust gas stream from the exhaust manifold 120 to a downstream component, such as the aftertreatment system 106 and/or the turbo device 112. In some embodiments, a first portion of the exhaust conduit 122 is disposed between the exhaust manifold 120 and turbo device 112. The first portion of the exhaust conduit 122 is configured to route the exhaust gas stream from the exhaust manifold 120 to turbo device 112. In some embodiments, a second portion of the exhaust conduit 122 is disposed between the turbo device 112 and the aftertreatment system 106. The second portion of the exhaust conduit 122 is configured to route the exhaust gas stream from the turbo device 112 to the aftertreatment system 106.

The aftertreatment system 106 is in exhaust gas receiving communication with the engine 102. The aftertreatment system 106 includes components used to reduce exhaust emissions, such as a selective catalytic reduction (SCR) catalyst, a diesel oxidation catalyst (DOC), a diesel particulate filter (DPF), an exhaust fluid doser with a supply of exhaust fluid, a plurality of sensors for monitoring the aftertreatment system (e.g., a nitrogen oxide (NOx) sensor, temperature sensors, etc.), and/or still other components. With gasoline spark-ignited engines, the aftertreatment system may be omitted or be structured differently than described.

The turbo device 112 may be any type of turbo machinery, such as a turbocharger, a variable geometry turbocharger, a power turbine, etc. The turbo device 112 may be operatively coupled to the engine 102 and/or another component of the system 100, such as a drivetrain, a battery, an electric machine, or other suitable component. In some embodiments, the turbo device 112 is configured to compress a gas stream (e.g., an intake gas stream, an exhaust gas stream, etc.) and provide the compressed gas stream to the engine 102. For example, as shown in FIG. 1, the turbo device 112 may be coupled to the intake manifold 113 such that the turbo device is operative to provide the compressed gas stream to the engine 102 (e.g., via the intake manifold 113).

As shown, a plurality of sensors 125 are included in the system 100. The number, placement, and type of sensors included in the system 100 is shown for example purposes only. That is, in other configurations, the number, placement, and type of sensors may differ.

The sensor 125a may be a battery sensor (e.g., a SOC sensor, etc.). As shown in FIG. 1, the SOC sensor 125a is coupled to the battery 114. In some embodiments, the SOC sensor may be a virtual sensor communicably coupled to the battery 114 and the controller 108. It should be understood that the location of the sensors may vary, and the system 100 may include more or fewer sensors than as shown in FIG. 1.

Additional sensors may be also included with the system 100. The sensors may include engine-related sensors (e.g., torque sensors, speed sensors, pressure sensors, flowrate sensors, temperature sensors, etc.). The sensors 125 may further include sensors associated with other components of the system 100, such as the engine 102 and/or the turbo device 112. For example, the sensor may include a speed sensor of the engine 102, a speed sensor of the transmission 124, or a speed sensor of the turbo device 112. In some embodiments, the system 100 may include a fuel quantity and injection rate sensor, fuel rail pressure sensor, etc.).

Further, various sensors 125 may be coupled to the each of the electric machine 104, the engine 102, or various other components of the system 100 (e.g., a wheel, an axle, etc.). For example, a sensor 125 may determine (e.g., measure, etc.) an engine speed or a motor generator speed. Further the sensors 125 may determine a transmission speed, an axle speed, or a wheel speed.

The system 100 may also include sensors 125 that may be gas constituent sensors (e.g., NOx sensors, oxygen sensors, H2O/humidity sensors, hydrogen sensors, etc.), temperature sensors, particulate matter (PM) sensors, flow rate sensors (e.g., mass flow rate sensors, volumetric flow rate sensors, etc.), other exhaust gas emissions constituent sensors, pressure sensors, some combination thereof, and so on. The temperature sensors may include an aftertreatment system component temperature sensor that is structured to acquire data indicative of a temperature of a component of the aftertreatment system 106, such as a catalyst member (e.g., a SCR catalyst member, a DOC catalyst member, etc.) a particulate filter, or other component of the aftertreatment system 106. The data from the sensor may be used to determine an engine braking mode for an engine braking operation.

The sensors 125 may be real or virtual (i.e., a non-physical sensor that is structured as program logic in the controller 108 that makes various estimations or determinations). For example, an engine speed sensor may be a real or virtual sensor arranged to measure or otherwise acquire data, values, or information indicative of a speed of the engine 102 (typically expressed in revolutions-per-minute). The sensor is coupled to the engine (when structured as a real sensor) and is structured to send a signal to the controller 108 indicative of the speed of the engine 102. When structured as a virtual sensor, at least one input may be used by the controller 108 in an algorithm, model, lookup table, etc. to determine or estimate a parameter of the engine (e.g., power output, etc.). Any of the sensors 125 described herein may be real or virtual.

The controller 108 is coupled, and particularly communicably coupled, to the sensors 125. Accordingly, the controller 108 is structured to receive data from one or more of the sensors 125 and provide instructions/information to the one or more sensors 125. The received data may be used by the controller 108 to control one or more components in the system 100 as described herein.

The operator input/output (I/O) device 110 may be coupled to the controller 108, such that information may be exchanged between the controller 108 and the I/O device, where the information may relate to one or more components of FIG. 1 or determinations (described below) of the controller 108. The operator I/O device enables an operator of the system 100 to communicate with the controller 108 and one or more components of the system 100 of FIG. 1. For example, the operator input/output device may include, but is not limited to, an interactive display, a touchscreen device, one or more buttons and switches, voice command receivers, etc. In this way, the operator input/output device may provide one or more indications or notifications to an operator, such as a malfunction indicator lamp (MIL), etc. Additionally, the system 100 may include a port that enables the controller 108 to connect or couple to a scan tool so that fault codes and other information regarding the system 100 may be obtained.

The controller 108 is structured to control, at least partly, the operation of the system 100 and associated sub-systems, such as the engine 102, electric machine 104, and the operator I/O device 110. Communication between and among the components may be via any number of wired or wireless connections. For example, a wired connection may include a serial cable, a fiber optic cable, a CAT5 cable, or any other form of wired connection. In comparison, a wireless connection may include the Internet, Wi-Fi, cellular, radio, etc. In one embodiment, a controller area network (CAN) bus provides the exchange of signals, information, and/or data. The CAN bus includes any number of wired and wireless connections. Because the controller 108 is communicably coupled to the systems and components of FIG. 1, the controller 108 is structured to receive data from one or more of the components shown in FIG. 1. The structure and function of the controller 108 is further described in regard to FIG. 2.

As the components of FIG. 1 are shown to be embodied in the system 100, the controller 108 may be structured as one or more electronic control units (ECUs), including or such as one or more microcontrollers. The controller 108 may be separate from or included with at least one of a transmission control unit, an exhaust aftertreatment control unit, a powertrain control module, an engine control unit, an engine control module, etc.

Now referring to FIG. 2, a schematic diagram of the controller 108 of the system 100 of FIG. 1 is shown, according to an example embodiment. As shown, the controller 108 includes at least one processing circuit 202 having at least one processor 204 and at least one memory device 206. The controller 108 is structured to facilitate enabling a drive mode operation, select, and implement a particular drive mode of operation based on current operating parameters of the system. In some embodiments, the drive mode operation includes selecting a drive mode of at least one of an electric vehicle drive mode, a recharge drive mode, an engine only drive mode, or a power split drive mode.

In the example shown, the controller 108 includes the processing circuit 202 having the processor 204 and the memory device 206. The processing circuit 202 may be structured or configured to execute or implement the instructions, commands, and/or control processes.

The processor 204 may be implemented as one or more single-or multi-chip processors, digital signal processors (DSPs), application specific integrated circuits (ASICs), field programmable gate arrays (FPGAs), and/or suitable processors (e.g., other programmable logic devices, discrete hardware components, etc. to perform the functions described herein). A processor may be a microprocessor, a group of processors, etc. A processor also may be implemented as a combination of computing devices, such as a combination of a DSP and a microprocessor, a plurality of microprocessors, one or more microprocessors in conjunction with a DSP core, or any other such configuration. In some embodiments, the one or more processors may be shared by multiple circuits. In other embodiments, the one or more processors may be structured to perform or otherwise execute certain operations independent of one or more co-processors. In other example embodiments, two or more processors may be coupled via a bus to enable independent, parallel, pipelined, or multi-threaded instruction execution. All such variations are intended to fall within the scope of the present disclosure.

The memory device 206 (e.g., memory, memory unit, storage device) may include one or more devices (e.g., RAM, ROM, Flash memory, hard disk storage) for storing data and/or computer code comprising instructions for completing or facilitating the various processes, layers and modules described in the present disclosure. For example, the memory device 206 may include dynamic random-access memory (DRAM). The memory device 206 may be communicably connected to the processor 204 to provide computer code or instructions to the processor 204 for executing at least some of the processes described herein. Moreover, the memory device 206 may be or include tangible, non-transient volatile memory or non-volatile memory. Accordingly, the memory device 206 may include database components, object code components, script components, or any other type of information structure for supporting the various activities and information structures described herein.

The communications interface 216 may include any combination of wired and/or wireless interfaces (e.g., jacks, antennas, transmitters, receivers, transceivers, wire terminals) for conducting data communications with various systems, devices, or networks structured to enable in-vehicle communications (e.g., between and among the components of the vehicle) and out-of-vehicle communications (e.g., with a remote server). For example, and regarding out-of-vehicle/system communications, the communications interface 216 may include an Ethernet card and port for sending and receiving data via an Ethernet-based communications network and/or a Wi-Fi transceiver for communicating via a wireless communications network. The communications interface 216 may be structured to communicate via local area networks or wide area networks (e.g., the Internet) and may use a variety of communications protocols (e.g., IP, LON, Bluetooth, ZigBee, radio, cellular, near field communication).

As shown in FIG. 2, the communications interface 216 may enable communication with the engine 102, the electric machine 104, and/or the one or more sensors 125. In some embodiments, the communications interface 216 may enable communication with the electric machine 104.

The controller 108 is structured to control, at least partly, operation of the system 100 (e.g., hybrid powertrain system). For example, the controller 108 is structured to enable operation of at least one of the engine 102 and the electric machine 104. The controller 108 may enable operation of at least one of the engine 102 and the electric machine 104 based on a predetermined set speed threshold or power thresholds, or an adjusted speed threshold or power thresholds based on current operating parameters of the system 100.

The controller 108 is structured or configured to estimate a weight of the system (e.g., a vehicle weight, etc.). For example, the system 100 may include a plurality of sensors 125, including weight sensors, communicably coupled to the controller 108 to determine a value indicative of an estimated weight (e.g., a mass, a load etc.) of the vehicle system 100. The controller 108 may receive an estimated weight from a sensor 125 and store the estimated weight in the memory device 206. In some embodiments, the sensor may automatically (e.g., after a predetermined amount of time, etc.) measure the weight, mass, or load of the vehicle system 100 and provide the controller 108 with an updated estimated weight value. In other embodiments, the sensor 125 may provide the controller 108 with an updated estimated weight value in response to determining (e.g., sensing, measuring, etc.) that the weight of the vehicle system 100 has changed. For example, if objects are removed (e.g., unloaded, etc.) from the vehicle system 100, the sensor 125 may determine the weight change and provide the controller 108 with an updated estimated weight. The controller 108 may then store the updated estimated weight value in the memory device 206.

The controller 108 is configured to receive a value indicative of an operating parameter(s) of the system 100. For example, the controller may receive a value indicative of a state of charge (SOC) of the battery 114. In other embodiments, the controller 108 may receive a temperature value indicative of the temperature of the engine or the electric machine. In yet another embodiment, the controller 108 may receive a value indicative of the health of the battery 114.

Further, the controller 108 may store the value (e.g., the SOC value, the temperature, etc.) in the memory device 206. The controller 108 may set an operating condition (e.g., a state of charge (SOC), etc.) threshold for the system 100. For example, the controller 108 may set a first SOC threshold or a temperature threshold. The first SOC threshold may be a low SOC limit value. In response to receiving the SOC value, the controller 108 is structured to compare the received SOC value with the first SOC threshold. If the controller 108 determines that the SOC value is less than or equal to the SOC threshold, the controller 108 is configured to set the speed threshold to a predefined low value (e.g., zero) and enable at least one of the engine 102 and/or the electric machine 104 to provide the power. For example, if the SOC value is less than the first SOC threshold, the system 100 may not operate solely on electrical power (e.g., electric vehicle mode, EV mode, etc.). In other embodiments, the controller may determine a plurality of SOC thresholds.

The controller 108 is also configured to receive a power demand (e.g., a DDP). The DDP may be determined by one of the plurality of sensors 125. For example, the DDP may be determined by a sensor 125 that determines the position of the accelerator or the brake (e.g., the APP or the BPP). For example, based on the position of the accelerator, the controller 108 may determine that vehicle system 100 may require more power to maintain a current speed, or accelerate the vehicle, or require less power when decelerating, or braking.

If the value of one or more predefined operating parameters is greater than the operating parameter threshold, the controller 108 may set a speed threshold based on the value regarding the vehicle weight. For example, if the SOC value is greater than the first SOC threshold, the controller 108 is configured to determine a speed threshold based on the vehicle weight. The controller 108 is also configured to determine a first power threshold (e.g., a lower power threshold) and a second power threshold (e.g., an upper power threshold). For example, the first power threshold and the second power threshold are set such that during vehicle operation the SOC is kept within a predetermined range.

In an example scenario, if the controller 108 receives a value indicative of an operating parameter that is less than the operating parameter threshold, the controller 108 may set the system 100 to operate in a drive mode where the system's power is provide by the engine 102 or the engine 102 and the electric machine 104. For example, if the SOC value is less than the SOC threshold, the controller 108 is configured to enable at least one of the engine 102 and the electric machine 104, such that the vehicle system 100 may not rely solely on the electric machine 104 for power (e.g., torque, etc.). In this embodiment, the controller 108 sets the speed threshold to a predefined low value (e.g., zero). For example, in this scenario, the SOC value may indicate that the battery 114 does not have sufficient charge to supply power to the engine system 100 without enabling the engine 102. In this scenario, the controller 108 is configured to set a drive mode based on the DDP.

When the value regarding the operating condition is less than the predefined operating condition threshold, such as the SOC is below the SOC threshold, the controller 108 is structured to determine if the DDP is less than the first power threshold (e.g., the lower power threshold). In response to determining the DDP is less than or equal to the first power threshold, the controller 108 may enable an engine recharge drive mode. For example, the controller 108 may enable the system's power to be provided by the engine 102 and also enable the electric machine 104 to provide power to the battery 114 to charge the battery (e.g., increase the SOC, etc.). When the engine recharge drive mode is enabled, only the engine 102 provides power (e.g., torque, etc.). The electric machine 104 is active (e.g., on, running, etc.) but is signaled to only provide power back to the battery 114 (e.g., negative power).

In response to determining that the DDP is greater than the first power threshold, the controller 108 is structured to determine if the DDP is less than or equal to the second power threshold. For example, if the DDP is greater than the first power threshold but less than or equal to the second power threshold, the controller 108 may enable an engine only mode. When the controller 108 enables an engine only mode, the controller 108 sends at least one signal (e.g., a command, message, etc.) to the engine 102 to enable (e.g., turn on, activate, etc.) the engine 102 to provide power. The controller 108 may also send a signal (e.g., command, message, etc.) to the electric machine 104 to shut down (e.g., turn off, disable, etc.) the electric machine 104. The controller 108 is configured to enable only the engine 102 to provide power to the system 100 during the engine only drive mode.

Further, in response to determining that the DDP is greater than the second power threshold (e.g., greater than each of the first power threshold and the second power threshold), the controller 108 is structured to enable a power split drive mode. When the power split drive mode is enabled, the controller 108 is configured to send a command to the each of the engine 102 and the electric machine 104 such that the system's power is provided by both the engine 102 and the electric machine 104.

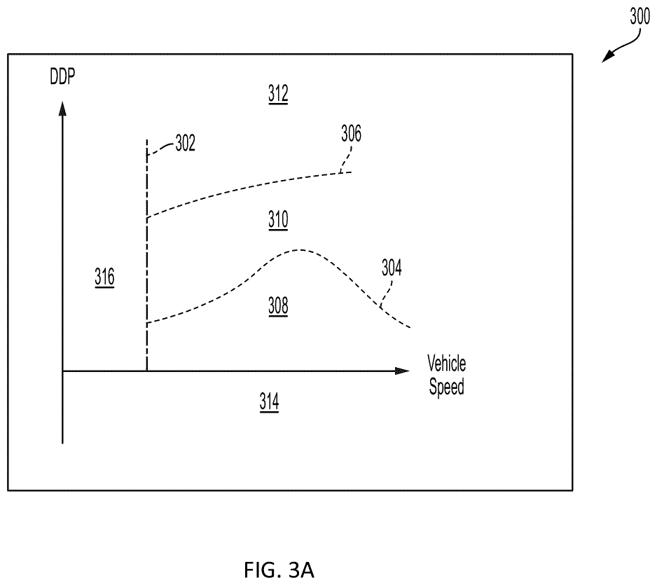

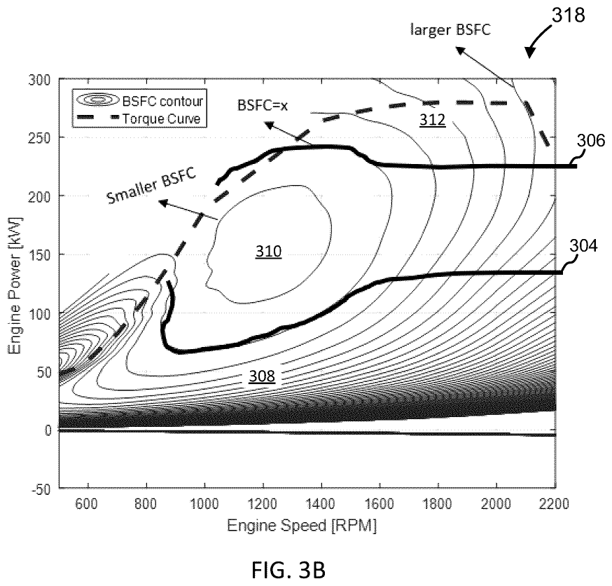

Referring now to FIG. 3A, a drive mode decision diagram is illustrated according to an example embodiment. For example, the diagram shown in FIG. 3A may represent the speed threshold and power limit thresholds used by the controller 108 select a drive mode. As shown in

FIG. 3A, the diagram 300 includes a speed threshold line 302. According to this embodiment, the speed threshold line 302 is a vertical line positioned a distance away from the y-axis (e.g., the DDP axis). In other embodiments, the speed threshold line 302 may be positioned on top of the y-axis (e.g., the speed threshold equals zero, X=0, etc.). The speed threshold line 302 is determined based on a function of the estimated vehicle weight and the SOC level. For example, when the SOC is less than or equal to the first SOC threshold, the speed threshold line 302 is equal to zero (e.g., X=0). When the SOC is greater than the first SOC threshold, the speed threshold line 302 is determined based on the vehicle weight. For example, when the SOC is greater than the first SOC threshold, the speed threshold line 302 is greater than zero (e.g., X=5, X=10, etc.).

The graph 300 also includes a first power threshold line 304 and a second power threshold line 306. In response to determining, by the controller 108, that the vehicle speed is greater than the speed threshold 302 and the DDP is below the first power threshold line 304, the controller 108 is configured to enable the system 100 to operate in an engine recharge drive mode 308. In response to determining, by the controller 108, that the vehicle speed is greater than the speed threshold 302 and the DDP above the first power threshold line 304 but below the second power threshold line 306, the controller 108 is configured to enable the system 100 to operate in an engine only drive mode 310. In response to the speed is greater than the speed threshold 302 and the DDP above the second power threshold line 306, the controller 108 is configured to enable the system 100 to operate in a power split drive mode 312. When in a power split drive mode, the system's power is provided by the engine 102 and the electric machine 104.

Further, if the controller receives a DDP equaling to or below zero, the controller 108 enables a regenerative drive mode. When the regenerative drive mode 314 is enabled, power is received by the system 100 and stored in the battery 114. For example, regenerative braking or coasting may be examples of the regenerative drive mode 314.

As shown in FIG. 3A, if the value indicating an operating condition is great than the operating condition threshold, (e.g., the SOC is greater than the first SOC threshold) and the vehicle speed is less than the speed threshold, the controller 108 is structured to enable the system 100 to operate in an electric vehicle drive mode 316. In electric vehicle drive mode, the controller 108 is configured to enable only the electric machine 104 to provide power to the system 100. For example, the system's power is provided by the electric machine 104 while the engine 102 is turned off.

The first power threshold line 304 (e.g., the first power threshold, the first power limit, etc.) and the second power threshold line 306 (e.g., the second power threshold, the second power limit, etc.) may initially be determined from a system efficiency map 318 of the system 100 as shown in FIG. 3B. The system efficiency map may be only an engine thermal efficiency map or a combined engine thermal efficiency map and an electric machine efficiency map. For example, if the system efficiency map is an engine thermal efficiency map as shown in FIG. 3B, a brake specific fuel consumption (BSFC) curve can be selected (e.g., chosen, determined, identified, etc.). For example, the BSFC may be equal to 190 BSFC. In other embodiments, other values for the BSFC may be chosen. As shown in FIG. 3B, when the speed is above the speed limit and the DDP is below the lower edge of the 190 BSFC curve (e.g., the first power threshold line 304), the controller 108 is structured to enable the system 100 to operate in the engine recharge drive mode 308. When the speed is above the limit and the DDP is below the upper edge of the 190 BSFC curve (e.g., the second power threshold line 306) and above (e.g., greater than, etc.) the lower edge of the 190 curve (e.g., the first power threshold line 304), the controller is structured to enable the system 100 to operate in the engine only drive mode 310. When the speed is greater than the speed limit and the DDP is greater than the upper edge of the 190 BSFC curve (e.g., the second power threshold line 306), the controller is structured to enable the system 100 to operate in the power split drive mode 312. The engine recharge drive mode 308 and the power split drive mode 312 are different types of hybrid modes. When the DDP is above the second power threshold line 306 or below the first power threshold line 304 (e.g., the DDP is very high or very low), the engine's efficiency will be relatively low. Thus, by operating in a hybrid mode (e.g., engine recharge drive mode 308, power split drive mode 312, etc.) the engine can maintain operating in a high efficiency zone by also operating the electric machine or motor generator 104 (e.g., allocating power between the engine and the motor generator, etc.).

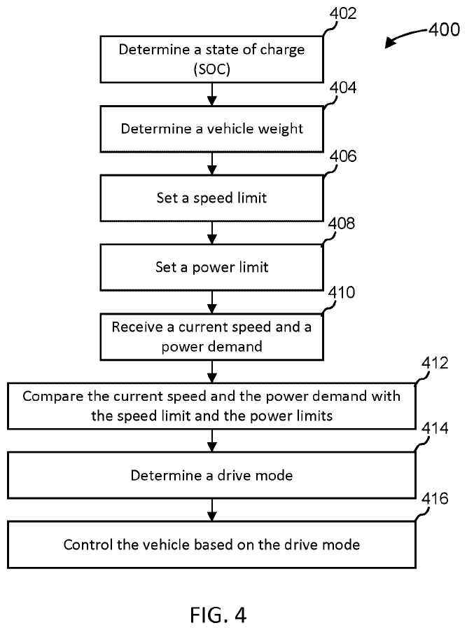

Based on the foregoing and now referring to FIG. 4, a flow diagram of a method 400 of enabling a drive mode is shown, according to an example embodiment. In particular, the controller 108 is structured to enable a drive mode operation based on a current speed and a power demand (DDP) of the system 100.

At process 402, the controller 108 determine or receives a value indicative of an operating condition (e.g., a state of charge (SOC) of the vehicle battery 114). As described above, the controller 108 may receive a SOC value from a sensor 125 or a virtual sensor. During process 402, the controller 108 may receive the SOC value from the sensor 125 and store the SOC value in the memory device 206.

At process 404, the controller 108 determines a value regarding a vehicle weight (e.g., a sensed weight, a vehicle mass, a vehicle load etc.). As described above, the controller 108 may receive an estimated vehicle weight from one of the plurality of sensors 125 or a virtual sensor. During process 404, the controller 108 may receive the vehicle weight from the sensor 125 and store the vehicle weight in the memory device 206. In this embodiment, the controller 108 may perform process 402 before performing process 404. In some embodiments, process 402 and process 404 may occur simultaneously. In other embodiments, process 404 may be conducted before process 402.

At process 406, the controller sets a speed threshold (e.g., a speed threshold). During process 406, the controller is configured to compare the SOC with the first SOC threshold. In response, to determining that the SOC level is less than the first SOC threshold, the controller 108 is structured to set the speed threshold to zero. Further, in response to determining that the SOC level is greater than the first SOC threshold, the controller 108 is structured to set (e.g., calculate) the speed threshold based on a function of the value regarding a vehicle weight.

At process 408, the controller 108 sets a power threshold (e.g., a power threshold, a first power threshold, a second power threshold, etc.). The controller 108 is structured to determine the first power threshold and the second power threshold based on a predetermined SOC range. For example, the controller 108 may be structured to set the first power threshold and the second power threshold such that the SOC remains within a desirable range during vehicle operation.

At process 410, the controller 108 receives a current vehicle speed and a current power demand (DDP). For example, the controller 108 may receive the current speed from a speed sensor 125 (e.g., a speedometer, etc.). The controller 108 may receive the DDP from a sensor 125 that senses at least one of driver demanded torque (DDT,) accelerator pedal position (APP), or brake pedal position (BPP). The controller 108 may be structured to store the vehicle speed and the DDP in the memory device 206.

At process 412, the controller is structured to compare the current vehicle speed to the set speed threshold and compare the DDP to each of the set first (e.g., lower) power threshold and the set second (e.g., upper) power threshold. As described above, the controller 108 determines if the speed is greater than the speed threshold and determines if the DDP is less than the first power threshold, greater than the first power threshold and less than the second power threshold, or greater than the second power threshold.

At process 414, the controller selects a drive mode (e.g., electric vehicle drive mode, engine recharge drive mode, engine only drive mode, power split drive mode, or regenerative drive mode). At process 416, the controller 108 enables the selected drive mode. For example, the controller 108 may send a command to enable at least one of the engine 102 and/or the electric machine 104. For example, the controller 108 allocates at least one of the engine 102 and/or the electric machine 104 to provide power to the system.

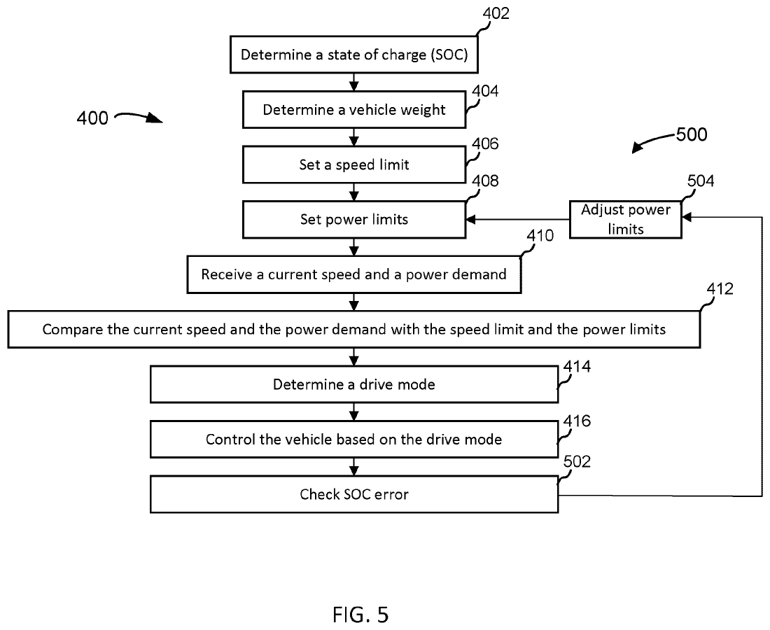

Now referring to FIG. 5, a flow diagram of a method 500 for adjusting the power thresholds included in the method 400 of enabling a drive mode is shown, according to an example embodiment. In particular, the controller 108 is structured to receive a value indicative of an operating parameter (e.g., an SOC command, an error command, an SOC error command, etc.) and adjust the power thresholds based on the value.

As described above, the method 500 includes the method 400. After process 416, the controller 108 is structured to receive a command (e.g., SOC command, error command, etc.) (process 502). At process 502, the controller 108 is structured to adjust (e.g., change, recalculate, increase, decrease, etc.) the first power threshold and the second power threshold in response to the command. For example, the controller 108 may adjust the first power threshold and the second power threshold in order to maintain the SOC level within a desirable range.

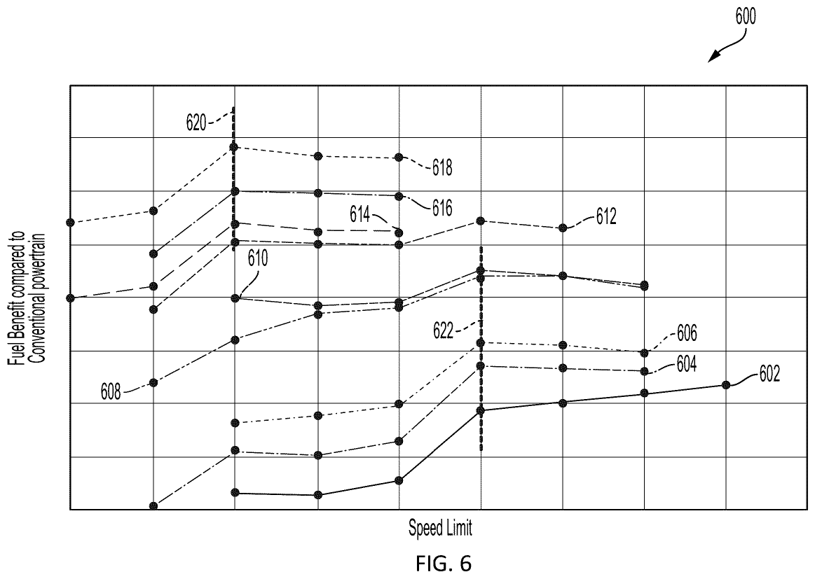

Based on the foregoing and now referring to FIG. 6, a graph 600 for determining the speed threshold 302 is shown according to an example embodiment. The horizontal axis of the graph illustrates vehicle speed and the vertical axis illustrate fuel benefit compared to a conventional powertrain. The graph 600 includes lines 602, 604, 606, 608, 610, 612, 614, 616, and 618, each representing a vehicle system of varying weight. For example, the vehicle systems represented by 602-618 may increase in weight such that 602 represents the lightest vehicle system and 618 represents the heaviest vehicle system. The speed threshold 302 is determined based on the peak fuel benefit for each vehicle system 602-618. For example, the speed threshold 302 may decrease as the weight of the vehicle system increases. The peak fuel benefit of each vehicle system 602-618 may be determined by simulation. For example, the lines can be obtained by simulations by setting different vehicle weight or load values.

According to this embodiment, the speed threshold is determined by the speed at which the vehicle system 602-618 reaches peak fuel benefit (or another predefined fuel economy or lowest fuel consumption value, such as a desired MPG value). According to this embodiment, if the vehicle weight is greater than the vehicle weight of line 610, the speed threshold is set to a first speed threshold 620 (e.g., 30 km/hr., etc.). If the vehicle weight is less than or equal to the vehicle weight of line 610, the speed threshold may be set to a second speed threshold 622 (e.g., 40 km/hr.).

Advantageously, adjusting at least one of the first power threshold or the second power threshold may increase the fuel economy of the vehicle system 100. For example, if the SOC is continuously greater than the first SOC threshold, it may be advantageous for the controller to adjust the first power threshold and the second power threshold such that controller 108 may enable a drive mode that utilizes power from the electric machine 104. Similarly, if the controller 108 is continuously receiving error commands, the controller 108 may advantageously adjust at least one of the first power threshold and/or the second power threshold such that the SOC stays within a desired predetermined range.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using one or more separate intervening members, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic. For example, circuit A communicably “coupled” to circuit B may signify that the circuit A communicates directly with circuit B (i.e., no intermediary) or communicates indirectly with circuit B (e.g., through one or more intermediaries).

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

While various circuits with particular functionality are shown in FIG. 2, it should be understood that the controller 108 may include any number of circuits for completing the functions described herein. Further, the controller 108 may further control other activity beyond the scope of the present disclosure.

As mentioned above, executable code may, for instance, comprise one or more physical or logical blocks of computer instructions, which may, for instance, be organized as an object, procedure, or function. Nevertheless, the executables need not be physically located together, but may comprise disparate instructions stored in different locations which, when joined logically together, comprise the circuit and achieve the stated purpose for the circuit. Indeed, a computer readable program code may be a single instruction, or many instructions, and may even be distributed over several different code segments, among different programs, and across several memory devices. Similarly, operational data may be identified and illustrated herein within circuits and may be embodied in any suitable form and organized within any suitable type of data structure. The operational data may be collected as a single data set or may be distributed over different locations including over different storage devices, and may exist, at least partially, merely as electronic signals on a system or network.

While the term “processor” is briefly defined above, the term “processor” and “processing circuit” are meant to be broadly interpreted. In this regard and as mentioned above, the “processor” may be implemented as one or more processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud-based processor). Alternatively, or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud-based server). To that end, a “circuit” as described herein may include components that are distributed across one or more locations.

Embodiments within the scope of the present disclosure include program products comprising computer or machine-readable media for carrying or having computer or machine-executable instructions or data structures stored thereon. Such machine-readable media can be any available media that can be accessed by a computer. The computer readable medium may be a tangible computer readable storage medium storing the computer readable program code. The computer readable storage medium may be, for example, but not limited to, an electronic, magnetic, optical, electromagnetic, infrared, holographic, micromechanical, or semiconductor system, apparatus, or device, or any suitable combination of the foregoing. More specific examples of the computer readable medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible medium that can contain, and/or store computer readable program code for use by and/or in connection with an instruction execution system, apparatus, or device. Machine-executable instructions include, for example, instructions and data which cause a computer or processing machine to perform a certain function or group of functions.

The computer readable medium may also be a computer readable signal medium. A computer readable signal medium may include a propagated data signal with computer readable program code embodied therein, for example, in baseband or as part of a carrier wave. Such a propagated signal may take any of a variety of forms, including, but not limited to, electrical, electro-magnetic, magnetic, optical, or any suitable combination thereof. A computer readable signal medium may be any computer readable medium that is not a computer readable storage medium and that can communicate, propagate, or transport computer readable program code for use by or in connection with an instruction execution system, apparatus, or device. Computer readable program code embodied on a computer readable signal medium may be transmitted using any appropriate medium, including but not limited to wireless, wireline, optical fiber cable, Radio Frequency (RF), or the like, or any suitable combination of the foregoing.

In one embodiment, the computer readable medium may comprise a combination of one or more computer readable storage mediums and one or more computer readable signal mediums. For example, computer readable program code may be both propagated as an electro-magnetic signal through a fiber optic cable for execution by a processor and stored on RAM storage device for execution by the processor.

Computer readable program code for carrying out operations for aspects of the present disclosure may be written in any combination of one or more other programming languages, including an object-oriented programming language such as Java, Smalltalk, C++ or the like and conventional procedural programming languages, such as the “C” programming language or similar programming languages. The computer readable program code may execute entirely on the user's computer, partly on the user's computer, as a stand-alone computer-readable package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The program code may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the apparatus and system as shown in the various exemplary embodiments is illustrative only. Additionally, any element disclosed in one embodiment may be incorporated or utilized with any other embodiment disclosed herein.

What is claimed is:

1. A system for a vehicle, the system comprising:
a controller comprising at least one processing circuit comprising at least one memory coupled to at least one processor, the controller configured to:
receive a value regarding a weight of the vehicle;
receive a value indicative of an operating condition of an energy storage device coupled to the controller;
set, based on the value indicative of the operating condition of the energy storage device, a speed threshold for the vehicle;
set, based on the value indicative of the operating condition of the energy storage device, a first power threshold and a second power threshold;
receive a current speed and a power demand; and
in response to determining that the current speed is greater than the speed threshold, implement, based on the power demand, a predefined drive mode of a plurality of drive modes for the vehicle.

2. The system of claim 1, wherein the controller is further configured to define an energy threshold.

3. The system of claim 2, wherein the controller is further configured to:
in response to the value of the operating condition of the energy storage device being greater than the energy threshold, set the speed threshold to a predetermined speed.

4. The system of claim 3, wherein the controller is further configured to:
in response to the value of the operating condition of the energy storage device being less than or equal to the energy threshold, set the speed threshold to zero and the predefined drive mode to one of a recharge mode, an engine drive mode, or a power split mode.

5. The system of claim 3, wherein in response to the value of the operating condition of the energy storage device being greater than or equal to the energy threshold, the controller is further configured to:
in response to the power demand being less than the first power threshold, set the predefined drive mode to a recharge mode;
in response to the power demand being greater than the first power threshold and less than the second power threshold, set the predefined drive mode to an engine drive mode; and
in response to the power demand being greater than the second power threshold, set the predefined drive mode to a power split mode.

6. The system of claim 1, wherein the second power threshold is greater than the first power threshold.

7. The system of claim 1, wherein the controller is further configured to:
in response to the current speed not being greater than the speed threshold, implement an electric drive mode.

8. The system of claim 1, wherein the controller is further configured to:
adjust at least one of the first power threshold and the second power threshold.

9. A vehicle, comprising:
a motor configured to provide at least a portion of a power demand to the vehicle; and
a controller coupled to the motor, the controller configured to:
set a speed threshold based on a value regarding a vehicle weight and a value indicative of an operating condition of an energy storage device of the vehicle;
implement a drive mode based on the value indicative of the operating condition of the energy storage device and the speed threshold; and
control, based on the drive mode, the motor.

10. The vehicle of claim 9, wherein the controller is further configured to:
in response to the value indicative of the operating condition of the energy storage device being less than an energy threshold, set the speed threshold to zero.

11. The vehicle of claim 10, wherein the controller is further configured to:
in response to a current speed being less than the speed threshold and that the value indicative of the operating condition of the energy storage device being greater than or equal to the energy threshold, implement an electric vehicle drive mode.

12. The vehicle of claim 11, wherein the controller is further configured to:
set a first power threshold and a second power threshold based on the value indicative of the operating condition of the energy storage device.

13. The vehicle of claim 12, wherein the controller is further configured to:
in response to the current speed being greater than the speed threshold and the power demand being less than the first power threshold, implement an engine recharge mode wherein the motor provides power to the energy storage device.

14. The vehicle of claim 12, wherein the controller is further configured to:
in response to the current speed being greater than the speed threshold and the power demand being greater than the first power threshold and less than or equal to the second power threshold, implement an engine only drive mode.

15. The vehicle of claim 12, wherein the controller is further configured to:
in response to the current speed being greater than the speed threshold and the power demand being greater than the second power threshold, implement a power split mode wherein the motor provides a portion of the power demand to the vehicle.

16. A method, comprising:
receiving a value regarding a vehicle weight;
receiving a value indicative of an operating condition of an energy storage device;
setting, based on the value indicative of the operating condition of the energy storage device and the value regarding the vehicle weight, a speed threshold;
setting, based on the value indicative of the operating condition of the energy storage device, a first power threshold and a second power threshold;
receiving a current speed and a power demand; and
in response to the current speed being greater than the speed threshold, implementing a predefined drive mode of a plurality of drive modes based on the power demand.

17. The method of claim 16, further comprising:
setting an energy threshold; and
in response to the value of the operating condition of the energy storage device being less than or equal to the energy threshold, setting the speed threshold to zero and the predefined drive mode to one of a recharge mode, an engine mode, or a power split mode.

18. The method of claim 17, further comprising:
in response to the value indicative of the operating condition of the energy storage device being greater than the energy threshold and the power demand being less than the first power threshold, implementing the predefined drive mode to a recharge mode;
in response to the value indicative of the operating condition of the energy storage device being greater than the energy threshold and the power demand being greater than the first power threshold and less than the second power threshold, implementing the predefined drive mode to an engine mode; and
in response to the value indicative of the operating condition of the energy storage device being greater than the energy threshold and the power demand being greater than the second power threshold, implementing the predefined drive mode to a power split mode.

19. The method of claim 18, wherein implementing the recharge mode activates a motor to provide power to the energy storage device.

20. The method of claim 16, further comprising:
adjusting at least one of the first power threshold and the second power threshold.
